(19) United States
(12) Patent Application Publication
(10) Pub. No.: US 2020/0305338 A1
(43) Pub. Date: Oct. 1, 2020

(54) AGRICULTURE SUPPORT SYSTEM

(71) Applicant: KUBOTA CORPORATION, Osaka (JP)

(72) Inventors: Hirokazu SASAMOTO, Sakai-shi (JP); Izuru SHIMAMOTO, Sakai-shi (JP); Akinori UNESAKI, Sakai-shi (JP); Yoshiharu YOSHIMOTO, Sakai-shi (JP)

(21) Appl. No.: 16/903,553

(22) Filed: Jun. 17, 2020

Related U.S. Application Data
(63) Continuation of application No. PCT/JP2018/041815, filed on Nov. 12, 2018.

(30) Foreign Application Priority Data
Jan. 22, 2018 (JP) 2018-008281

(51) Int. Cl. A01B 79/00

(52) U.S. Cl. CPC A01B 79/005

(57) ABSTRACT

An agriculture support system includes an agriculture support device including a work creator to create a work plan of an agricultural operation to be performed by an agriculture machine, and a communicator to transmit the work plan from the work creator, and a display provided in the agriculture machine, including a machine information obtainer to obtain machine information of the agriculture machine, a plan obtainer to obtain the work plan transmitted from the communicator, an evaluator to compare the work plan with the machine information obtained by the machine information obtaining and to evaluate the work plan, and a display to display an evaluation result provided by the evaluator.

### CROSS REFERENCE TO RELATED APPLICATIONS

This application is a continuation application of International Application No. PCT/JP2018/041815, filed Nov. 12, 2018, which claims priority to Japanese Patent Application No. 2018-008281, filed Jan. 22, 2018. The entire contents of each of these applications are hereby incorporated herein by reference.

### BACKGROUND OF THE INVENTION

### 1. Field of the Invention

The present invention relates to an agriculture support system.

### 2. Description of the Related Art

Japanese Patent Publication No. 6122739 is known as a system for supporting the agricultural work to be performed by an agriculture machine.

The server of Japanese Patent Publication No. 6122739 includes a work plan setting means to set a work plan including crops, a plurality of agricultural fields, agricultural works, agricultural work periods for the agricultural works, and includes a work content planning means including the agricultural works and dates.

### SUMMARY OF THE INVENTION

An agriculture support system includes: an agriculture support device including: a work creator to create a work plan of an agricultural operation to be performed by an agriculture machine; and a communicator to transmit the work plan from the work creator; and a display provided in the agriculture machine, the display including: a machine information obtainer to obtain machine information of the agriculture machine; a plan obtainer to obtain the work plan transmitted from the communicator; and an evaluator to compare the work plan with the machine information obtained by the machine information obtaining and to evaluate the work plan; wherein the display displays an evaluation result provided by the evaluator.

The above and other elements, features, steps, characteristics and advantages of the present invention will become more apparent from the following detailed description of the preferred embodiments with reference to the attached drawings.

### BRIEF DESCRIPTION OF THE DRAWINGS

A more complete appreciation of preferred embodiments of the present invention and many of the attendant advantages thereof will be readily obtained as the same becomes better understood by reference to the following detailed description when considered in connection with the accompanying drawings described below.

FIG. 1 is a schematic diagram of an agriculture support system according to a preferred embodiment of the present invention.

FIG. 2 is a schematic diagram showing transmission of agricultural map data according to a preferred embodiment of the present invention.

FIG. 3 is a view illustrating an example of a creation screen M1 according to a preferred embodiment of the present invention.

FIG. 4 is a view showing registration of an agricultural field according to a preferred embodiment of the present invention.

FIG. 5 is a view illustrating a relation between the agricultural map data, an agricultural map, and a management number according to a preferred embodiment of the present invention.

FIG. 6 is a view illustrating an image of the agricultural map according to a preferred embodiment of the present invention.

FIG. 7 is a view illustrating an example of a work plan screen M3 according to a preferred embodiment of the present invention.

FIG. 8A is a view illustrating a screen M2 of a case where model numbers of a working device are matched with according to a preferred embodiment of the present invention.

FIG. 8B is a view illustrating the screen M2 of a case where model numbers of the working device are not matched with according to a preferred embodiment of the present invention.

FIG. 9A is a view illustrating an example of an operation map displayed in a first area according to a preferred embodiment of the present invention.

FIG. 9B is a view illustrating another example of the operation map of a case where an operation is interrupted according to a preferred embodiment of the present invention.

FIG. 10 is an explanation view explaining judgment to the operation according to a preferred embodiment of the present invention.

FIG. 11A is a view illustrating an example of display of a case where the operation is finished in discordance with the work plan according to a preferred embodiment of the present invention.

FIG. 11B is a view illustrating an example of display of a case where the operation is finished in accordance with the work plan according to a preferred embodiment of the present invention.

FIG. 12 is a view illustrating an example of a layer map screen M4 according to a preferred embodiment of the present invention.

### DETAILED DESCRIPTION OF THE PREFERRED EMBODIMENTS

The preferred embodiments will now be described with reference to the accompanying drawings, wherein like reference numerals designate corresponding or identical elements throughout the various drawings. The drawings are to be viewed in an orientation in which the reference numerals are viewed correctly.

Hereinafter, preferred embodiments of the present invention will be described with reference to the drawings as appropriate.

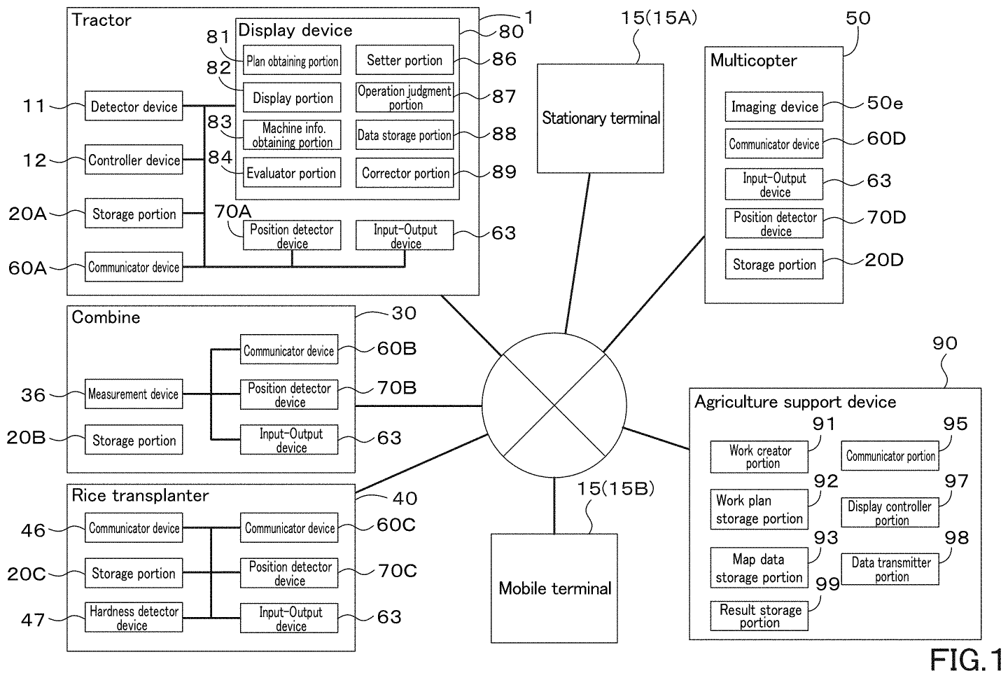

An agricultural support system is a system for supporting an agricultural work. In the agricultural support system, as illustrated in FIG. 1, a display device 80 provided on the agriculture machine, for example, acquires various types of information from the agriculture support device 90 to support the agricultural work to be executed by the agriculture machine. The agriculture machine is a tractor or a rice transplanter provided with a working device such as an implement, a combine for the harvesting, or the like. The agriculture machine 1 mentioned above is just an example and is not limited thereto.

First, an agriculture machine will be described with reference to the tractor 1 as a non-limiting example.

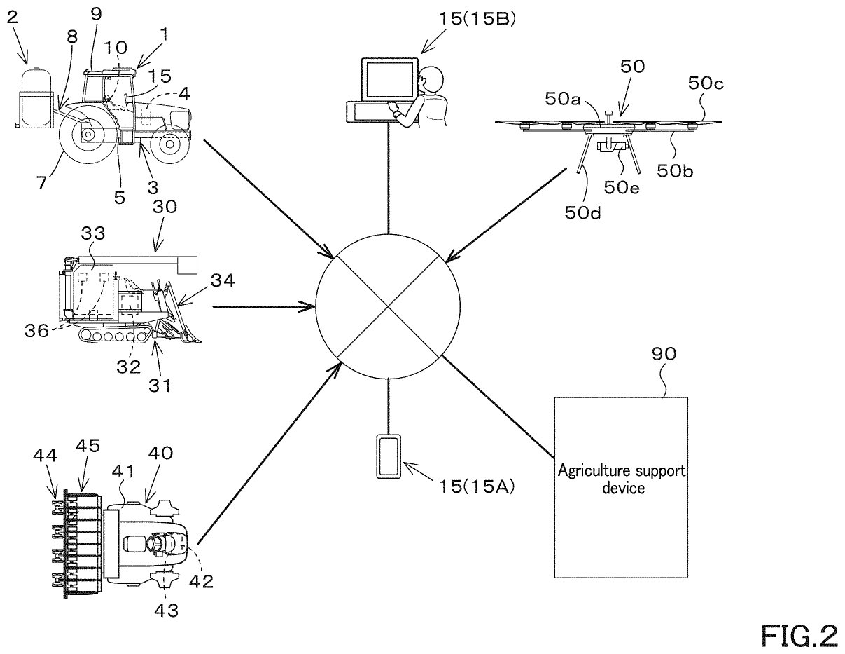

As shown in FIG. 2, the tractor 1 includes a traveling vehicle (a traveling vehicle body) 3 including a traveling device 7, a prime mover 4, and a transmission device 5. The traveling device 7 is a tire-type traveling device or a crawler-type traveling device. The prime mover 4 is a diesel engine, an electric motor, or the like. The transmission device 5 is capable of switching the propulsion force of the traveling device 7 through shifting of speeds, and is capable of switching the traveling device 7 between the forward traveling and the reverse traveling. The traveling vehicle 3 is provided with a cabin 9, and an operator seat 10 is provided inside the cabin 9.

In addition, a coupler portion 8 including a three-point link mechanism is provided at a rear portion of the traveling vehicle 3. The working device 2 is configured to be attached to/detached from the coupler portion 8. By coupling the working device 2 to the coupler portion 8, the working device 2 can be towed by the traveling vehicle 3. The working device 2 includes a tiller device for tilling, a fertilizer sprayer device for spraying fertilizer, a pesticide sprayer device for spraying pesticides, a harvester device for harvesting, a mower device for cutting grass and the like, a tedder device for tedding grass and the like, a rake device for raking grass and the like, a baler device for baling grass and the like, and the like.

As shown in FIG. 1, the tractor 1 includes a detector device 11 and a controller device 12. The detector device 11 is a device configured to detect the state of the tractor 1, and a device including sensors such as an accelerator pedal sensor, a shift lever detector sensor, a crank position sensor, a fuel sensor, a water temperature sensor, an engine revolving sensor, a steering angle sensor, an oil temperature sensor, an axle revolving sensor, an operation extent detector sensor and including switches such as an ignition switch, a parking brake switch, a PTO switch, and an operation switch. The controller device 12 is a device for controlling the tractor, and includes a CPU or the like. The controller device 12 controls the traveling system of the tractor 1 and the working system of the tractor 1 based on the detection values detected by the detector device 11 and the like. For example, the controller device 12 detects the operation extent of the operation tool for moving the coupler portion 8 up and down with the operation extent detector sensor, performs the control to move the coupler portion 8 up and down based on the operation extent, and control a revolving speed of the diesel engine based on the operation extent detected by the accelerator pedal sensor. The controller device 12 only needs to control the working system of the tractor 1 and the traveling system of the tractor 1, and the control method is not limited.

The tractor 1 includes a communicator device 60A. The communicator device 60A is a communication module configured to perform either the direct communication or the indirect communication with the agriculture support device 90, and is configured to perform the wireless communication in accordance with the Wi-Fi (Wireless Fidelity, a registered trademark) of the IEEE 802.11 series which is a communication standard, the BLE (Bluetooth (a registered trademark) Low Energy), the LPWA (Low Power, Wide Area), the LPWAN (Low-Power Wide-Area Network), or the like. In addition, the communicator device 60A is capable of performing the wireless communication through a mobile phone communication network or a data communication network, for example.

The tractor 1 includes a position detector device 70A. The position detector device 70A is mounted on a top plate of the cabin 9 of the traveling vehicle 3. The position detector device 70A is mounted on the top plate of the cabin 9. However, the mounting position in the traveling vehicle 3 is not limited thereto, and may be another position. In addition, the position detector device 70A may be attached to the working device 2.

The position detector device 70A is a device configured to detect its own position (the positioning information that includes latitude and longitude) in accordance with a satellite positioning system. That is, the position detector device 70A receives the signals (the position of positioning satellite, the transmission time, the correction information, and the like) transmitted from the positioning satellite, and then detects the position (latitude and longitude) based on the received signal. The position detector device 70A may detect, as its own position (latitude and longitude), a position corrected based on a signal such as a correction transmitted from a ground station (a reference station) capable of receiving a signal transmitted from the positioning satellite. In addition, the position detector device 70A may include an inertial measurement device such as a gyro sensor or an acceleration sensor, and may detect the position corrected by the inertial measurement device as its own position.

The tractor 1 includes a display device 80. The display device 80 is a device configured to display various types of information, and is a device having any one of a liquid crystal panel, a touch panel, and other panels. The display device 80 is connected to the detector device 11, the controller device 12, the communicator device 60A, and the position detector device 70A through the in-vehicle network. The display device 80 is configured to acquire and display a work plan of the agricultural work that is created by the agriculture support device 90 through the communicator device 60A or the like. Any one of the controller device 12, the communicator device 60A, and the display device 80 sequentially stores a detection value detected by the detector device 11, a position (a detected position) detected by the position detector device 70A, information relating to the work transmitted from the working device 2, and the like at least under the state where the tractor 1 is operating, are stores the sequentially-stored information is stored as work results.

As shown in FIG. 1, the agriculture support device 90 is a server installed in, for example, a farmer, a farming company, an agriculture machine constructor, an agricultural service provider, or the like. The agriculture support device 90 includes a work creator portion 91 and a storage portion (a work plan storage portion) 92. The work creator portion 91 includes electric/electronic components or circuitry provided in the agriculture support device 90, programs stored in the agriculture support device 90, or the like. The work plan storage portion 92 preferably includes a nonvolatile memory or the like.

The work creator portion 91 creates a work plan for agricultural work to be performed by an agriculture machine such as the tractor 1. The work plan is information indicating contents in which an agricultural field, an agricultural work, and a work date are associated with each other. The agricultural work is, for example, seedbed soil making, ridge plastering, tilling, seeding, fertilizing, rice planting, ploughing and irrigating, grooving, weeding, topdressing, harvesting, and the like.

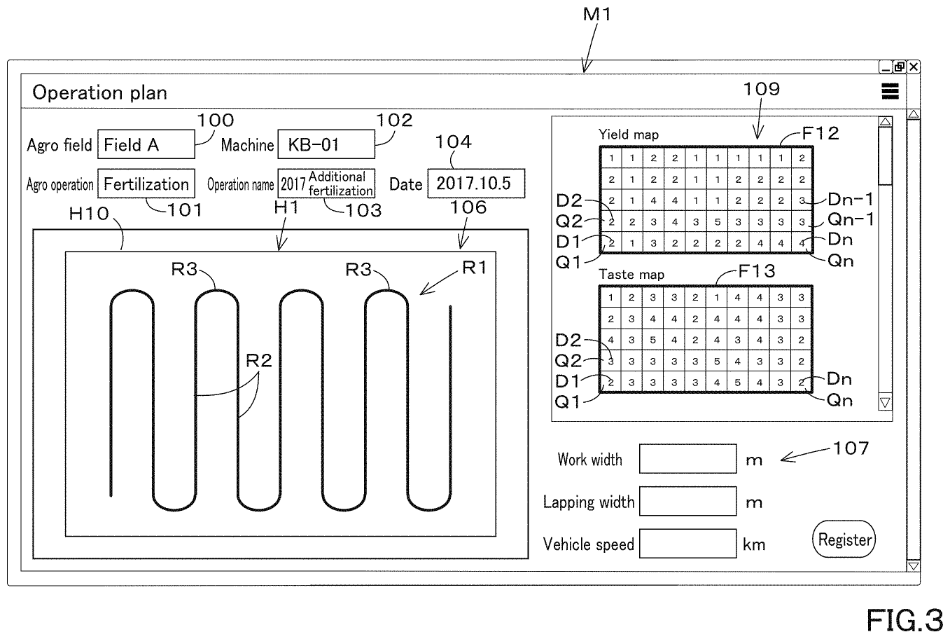

As shown in FIG. 1 and FIG. 3, when the external terminal 15 is connected to the agriculture support device 90 and the external terminal 15 requests to create a work plan, the work creator portion 91 displays a creation screen. M1 on the external terminal 15 in response to the request. The external terminal 15 is a personal computer, a smartphone, a tablet computer, a PDA, or the like. The external terminal 15 is divided into a stationary terminal 15A that is a personal computer and a mobile terminal 15B that is a smartphone, a tablet computer, and a PDA. For convenience of the explanation, the stationary terminal 15A and the mobile terminal 15B may be selectively operated to distinguish the external terminals 15.

The creation screen M1 displays an agricultural field input portion 100 for inputting an agricultural field where an agricultural work is executed, a work input portion 101 for inputting the agricultural work, a machine input portion 102 for inputting a machine, a name input portion 103 for inputting a name of the agricultural work, and a time input portion 104 for inputting a time. To the agricultural field input portion 100, information for specifying an agricultural field, for example, an agricultural field name, an agricultural field management number, and the like are inputted. To the work input portion 101, the agricultural work such as the seedbed soil making, the ridge plastering, the tilling, the seeding, the fertilizing, the rice planting, the ploughing and irrigating, the grooving, the weeding, the topdressing, and the harvesting are inputted. To the machine input portion 102, the model number, model, name and the like of the agriculture machine can be inputted, for example, the model number, model, name and the like of the working device 2 to be connected to the tractor 1 and the like are inputted. To the name input portion 103, an arbitrary name is inputted for the operator or the like to identify. To the time input portion 104, a work date, a work time, and the like for performing the agricultural work are inputted.

Thus, the work creator portion 91 can create, as the work plan, an agricultural field, an item of agricultural work, a model number, a model, a name of an agriculture machine (a working device) for performing the agricultural work, a work date for performing the agricultural work, and the like.

In addition, the work creator portion 91 can set not only the items of the agricultural work but also the procedure of the agricultural work as the work plan. The work creator portion 91 displays, on the creation screen M1, a field 106 (a route input portion) for inputting the scheduled traveling route R1 of the agriculture machine. In the field 106, the contour H10 of the agricultural field is displayed. Position information (latitude and longitude) of the field is assigned to the field 106, and the scheduled traveling route R1 is drawn based on a command from the external terminal 15 so that the positional information (latitude and longitude) is assigned to the scheduled traveling route R1. For example, as the scheduled traveling route R1, a straight traveling portion R2 that makes the tractor 1 go straight and a turning portion R3 that makes the tractor 1 turn both are set. The straight traveling portion R2 and the turning portion R3 in the traveling route R1 are associated with the positions (latitude and longitude) of the field 106, and at least the positions corresponding to the straight traveling portion R2 and the turning portion R3 can be set. The creation screen M1 may display a detail setting portion 107 for making detailed settings for the scheduled traveling route R1 such that the width (a working width) of the working device 2, a lapping width in which the working device 2 laps (overlaps) in the width direction in adjacent working areas, a vehicle speed, and the like are set.

Thus, the work creator portion 91 is capable of creating, as the work plan, the agricultural work, the model number, model and name of the agriculture machine (the working device), the work date, the scheduled traveling route R1, the working width, the lapping width, and the like. The work plan (the agricultural field, the agricultural work, the agriculture machine (the working device), the work date, the scheduled traveling route R1, the working width, the lapping width) created by the work creator portion 91 is stored in the work plan storage portion 92.

In creating the work plan, an agricultural map may be displayed on the creation screen M1, and the work plan may be created with reference to the agricultural map displayed on the creation screen M1. The agricultural map is a map obtained by visualizing agricultural map data acquired from various machines.

First, the type, acquisition, and the like of the agricultural map data (the agricultural map) will be described in detail.

The agricultural map data is data in which data relating to agriculture and positions are associated with each other, and includes field shape data, yield data, taste data, growth data, soil data, variable fertilization data, automatic traveling data, work history data, map data, and the like.

The field shape data is data representing a shape of the agricultural field. The yield data is data representing the crop yield, and the taste data is data representing the protein content of the crop. The growth data is data representing the growth of the crop, and is data obtained from vegetation indexes such as DVI, RVI, NDVI, GNDVI, SAVI, TSAVI, CAI, MTCI, REP, PRI, and RSI. The soil data is data representing the components of the soil, the hardness of the soil, and the like. The variable fertilization data is data representing the amount of fertilization when fertilization is performed. The automatic traveling data is data representing the scheduled traveling route R1. The work history data is data representing an actual travel locus when the tractor 1 or the like travels according to the scheduled traveling route R1. The map data is data obtained from the Geospatial Information Authority of Japan or from a map provider that provides maps. These agricultural map data can be obtained by various machines.

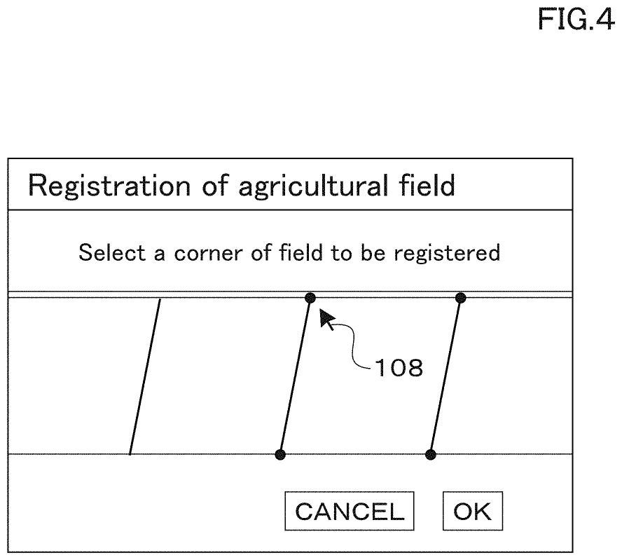

The field shape data can be acquired by the agriculture support device 90 and the external terminal 15. In particular, when an administrator or the like connects the external terminal 15 to the agriculture support device 90, the agriculture support device 90 acquires a map including an agricultural field from a map provider or the like, and causes the external terminal 15 to display the map. As shown in FIG. 4, the administrator or the like specifies, for example, a certain agricultural field from the maps displayed on the external terminal 15 with the pointer 108 or the like, and then specifies the outline of the specified agricultural field with the pointer 108. In this manner, the field shape data can be acquired.

The agriculture machine such as a tractor may be manually operated on orbit along the ridge of the agricultural field, and then the position detected by the position detector device 70A during the orbit operation may be used as the field shape data.

The automatic traveling data can be acquired by the agriculture support device 90. In particular, when the work creator portion 91 creates the scheduled travel route R1 as described above, the automatic travel data can be acquired by setting the created scheduled travel route R1 as the automatic travel data. That is, the agriculture support device 90 can acquire the automatic traveling data by incorporating the scheduled traveling route R1 created by the work creator portion 91 as one of the agricultural map data.

The yield data and the taste data can be acquired by the combine 30. As shown in FIG. 1 and FIG. 2, the combine 30 includes a vehicle body 31, a prime mover 32, a grain tank 33, a reaper device 34, a threshing device (not shown in the drawings), and a measuring device 36. The prime mover 32, the grain tank 33 and the threshing device are provided on the vehicle body 31. The reaper device 34 is provided at a front portion of the vehicle body 31. The reaper device 34 is a device configured to reap the cereals. The threshing device is a device configured to thresh the reaped cereals. The grain tank 33 is a tank configured to store the threshed cereals.

The measuring device 36 is a spectroscopic analyzer that measures the water content and the protein content of the harvested crops. Thus, the measuring device 36 can detect the crop yield, the moisture rate (the moisture content), and the protein rate (the protein content) of the crop.

The vehicle body 31 is provided with a position detector device 70B. The position detector device 70B is a device configured to detect a position (latitude and longitude), and has the same configuration as the position detector device 70A, and thus the description thereof will be omitted.

The combine 30 includes a storage portion 20B including a nonvolatile memory or the like. When the harvesting operation is performed by the combine 30, the storage portion 20B is capable of storing the yield data that associates the crop yield with the position detected by the position detector device 70B, and is capable of storing the protein content and the position detection. Taste data can be stored by associating the protein rate with the position detected by the position detector device 70B.

The growth data can be acquired by the multicopter 50 or the like. As shown in FIG. 1 and FIG. 2, the multicopter 50 includes a body 50a, an arm 50b provided on the body 50a, a rotary wing 50c provided on the arm 50b, and a skid 50d provided on the body 50a. The rotary wing 50c is a device configured to generate a lifting force for flying, and includes a rotor that provides a rotary force and a blade (a propeller) that rotates by the rotary force of the rotor. In addition, the multicopter 50 has an imaging device 50e. The imaging device 50e includes an infrared camera or the like, and is capable of shooting crops in an agricultural field.

In addition, the multicopter 50 includes a position detector device 70D. The position detector device 70D is configured to detect a position (latitude and longitude), and has the same configuration as that of the position detector device 70A, and thus the description thereof will be omitted.

The multicopter 50 flies over the agricultural field, aerially captures the crops on the agricultural field, and then associates the image captured by the imaging device 50e (the captured image) with the position detected by the position detector device 70D to obtain the image data. The image data is stored in the storage portion 20D provided in the multicopter 50. The image data is analyzed to be converted into a vegetation index. The storage portion 20D includes a nonvolatile memory or the like.

Thus, by flying the multicopter 50 over the agricultural field, the pre-conversion growth data in which original imaging data that is original data representing growth of crops is related to the position detected by the position detector device 70D can be obtained. The image data of the pre-conversion growth data is converted into the vegetation index with a computer or the like (not shown in the drawings) to create the growth data.

The rice transplanter 40 is capable of acquiring the soil data and the variable fertilization data. As shown in FIG. 1 and FIG. 2, the rice transplanter 40 includes a vehicle body 41, a prime mover 42, a transmission device 43, and a seedling planting device 44. The prime mover 42 and the transmission device 43 are provided on the vehicle body 41. The seedling planting device 44 is provided at a rear portion of the vehicle body 41. The seedling planting device 44 takes out, from the seedling stage 45, the seedlings mounted on the seedling stage 45 provided at the rear portion of the vehicle body 41, and plants them in an agricultural field or the like.

The working device 2 such as a fertilizer configured to perform the variable fertilization or the like can be attached to the rear portion of the vehicle body 41. In addition, the vehicle body 41 is provided with a position detector device 70C. The position detector device 70C is a device configured to detect a position (latitude and longitude), and has the same configuration as that of the position detector device 70A, and thus the description thereof will be omitted.

The rice transplanter 40 includes a storage portion 20C. When the rice transplanter 40 performs the rice transplanting operation, the storage portion 20C associates the fertilization amount performed by the fertilizer with the position detected by the position detector device 70C, and thereby acquires and stores the variable fertilization data.

The rice transplanter 40 includes a hardness detector device 47 configured to detect the hardness of the soil. The hardness detector device 47 detects the hardness of the soil based on the ups and downs (vertical fluctuation) of the vehicle body 41 when the rice transplanter 40 performs the rice transplanting operation. When the rice transplanter 40 performs the rice transplanting operation, the storage portion 20C associates the hardness detected by the hardness detector device 47 with the position detected by the position detector device 70C, and thereby obtains and stores the soil data by.

The work history data can be acquired by the tractor 1. Note that the automatic traveling data and the work history data can be acquired respectively by each of the combine 30 and the rice transplanter 40, when replacing the tractor 1 with the combine 30 and the rice transplanter 40.

The tractor 1 is configured to acquire the scheduled traveling route R1 created by the agriculture support device 90 or the like. When the tractor 1 is in a mode for the automatic traveling, the tractor 1 travels while automatically steering the steering or the like along the scheduled traveling route R1 acquired above. The storage portion 20A stores the position detected by the position detector device 70A when the tractor 1 performs the automatic traveling. That is, the work operation history data can be acquired by storing, to the storage portion 20A, the position of the tractor 1 as the traveling locus when the tractor 1 travels based on the scheduled traveling route R1.

When the tractor 1, the combine 30, the rice transplanter 40, and the multicopter 50 are respectively provided with the communicator devices 60A, 60B, 60C, and 60D, the agricultural map data is transmitted to the agriculture support device 90 with use of the communicator devices 60A, 60B, 60C, and 60D.

The communicator devices 60A, 60B, 60C, and 60D are communication modules configured to perform either the direct communication or the indirect communication with the agriculture support device 90, and configured to perform the wireless communication in accordance with the Wi-Fi (Wireless Fidelity, a registered trademark) of the IEEE 802.11 series which is a communication standard, the BLE (Bluetooth (a registered trademark) Low Energy), the LPWA (Low Power, Wide Area), the LPWAN (Low-Power Wide-Area Network), or the like, for example. In addition, the communicator devices 60A, 60B, 60C, and 60D are capable of performing the wireless communication through a mobile phone communication network or a data communication network, for example.

In the direct communication, the agriculture support device 90 requests the communicator devices 60A, 60B, 60C, and 60D to transmit agricultural map data regularly or irregularly. When the communicator devices 60A, 60B, 60C, and 60D receive the request for transmission of the agricultural map data, the tractor 1, the combine 30, the rice transplanter 40, and the multicopter 50 transmit the agricultural map data stored in the storage portions 20A, 20B, 20C, and 20D to the agriculture support device 90 through the communicator devices 60A, 60B, 60C, and 60D, in response to the request. Alternatively, in the direct communication, the agricultural map data of the storage portions 20A, 20B, 20C, and 20D are transmitted, to the agriculture support device 90, from the communicator devices 60A, 60B, 60C, and 60D provided in the tractor 1, the combiner 30, the rice transplanter 40, and the multicopter 50.

In the direct communication, when the agriculture support device 90 receives the image data that is the source of the growth data, the agriculture support device 90 may convert the image data into the growth data.

In the indirect communication, the communicator devices 60A, 60B, 60C, and 60D periodically or irregularly transmit, to the terminal 15B, the agricultural map data stored in the storage portions 20A, 20B, 20C, and 20D. Upon receiving the agricultural map data, the terminal 15B stores (saves) the agricultural map data that is temporarily received. The agriculture support device 90 requests the terminal 15B to transmit the agricultural map data regularly or irregularly. When the terminal 15B receives the request for transmission of the agricultural map data, the terminal 15B transmits the agricultural map data, which is temporarily stored, to the agriculture support device 90. Alternatively, in the indirect communication, the agricultural map data is transmitted from the terminal 15B to the agriculture support device 90. In the indirect communication, when the terminal 15B receives the image data that is the source of the growth data, the terminal 15B may convert the image data into the growth data. Alternatively, similarly to the direct communication, the agriculture support device 90 may convert the image data into the growth data after the agriculture support device 90 receives the image data.

Each of the tractor 1, the combine 30, the rice transplanter 40, and the multicopter 50 is provided with an input/output device 63 to which a storage medium such as a USB memory or an SD card, which is an electronic storage medium, can be connected when the communicator devices 60A, 60B, 60C, and 60D are not provided in the tractor 1, the combine 30, the rice transplanter 40, and the multicopter 50. The input/output device 63 is provided in the controller devices, the display devices, and the like of the tractor 1, the combine 30, the rice transplanter 40, the multicopter 50, and is capable of writing data to a storage medium and acquiring information of the storage medium. When the input/output device 63 is connected to the storage medium, the agricultural map data stored in the storage portions 20A, 20B, 20C, and 20D is transferred to the storage medium. The storage medium is capable of being connected to the terminals 15A and 15B. When the storage medium is connected to the terminals 15A and 15B, the agricultural map data stored in the storage medium is transferred to the terminals 15A and 15B. The terminal 15A and the terminal 15B transmit the agricultural map data to the agriculture support device 90. In the case where the storage medium is used, the terminals 15A and 15B may convert the image data into growth data when the terminals 15A and 15B receive the image data. Alternatively, similarly to the direct communication, the agriculture support device 90 may convert the image data into growth data after the agriculture support device 90 receives the image data.

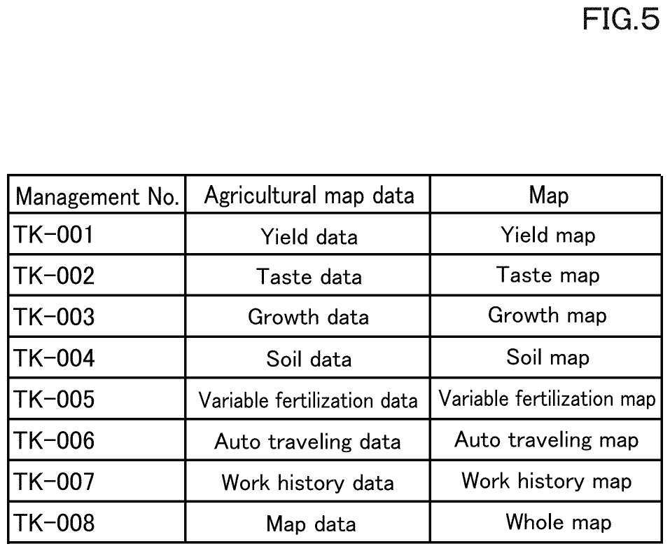

As shown in FIG. 1, the agriculture support device 90 has a map data storage portion 93. The map data storage portion 93 includes a nonvolatile memory or the like, and stores the acquired agricultural map data (the field shape data, the yield data, the taste data, the growth data, the soil data, the variable fertilization data, the automatic traveling data, the work history data, the map data). Specifically, as shown in FIG. 5, when the agriculture support device 90 acquires the agricultural map data, the map data storage portion 93 allocates the management information indicated by characters, alphanumeric characters, and the like in the agricultural map data acquired above, and the agricultural map data is stored together with the management information. The management information is information set to make it easy to calculate, search, organize, and the like of the agricultural map data.

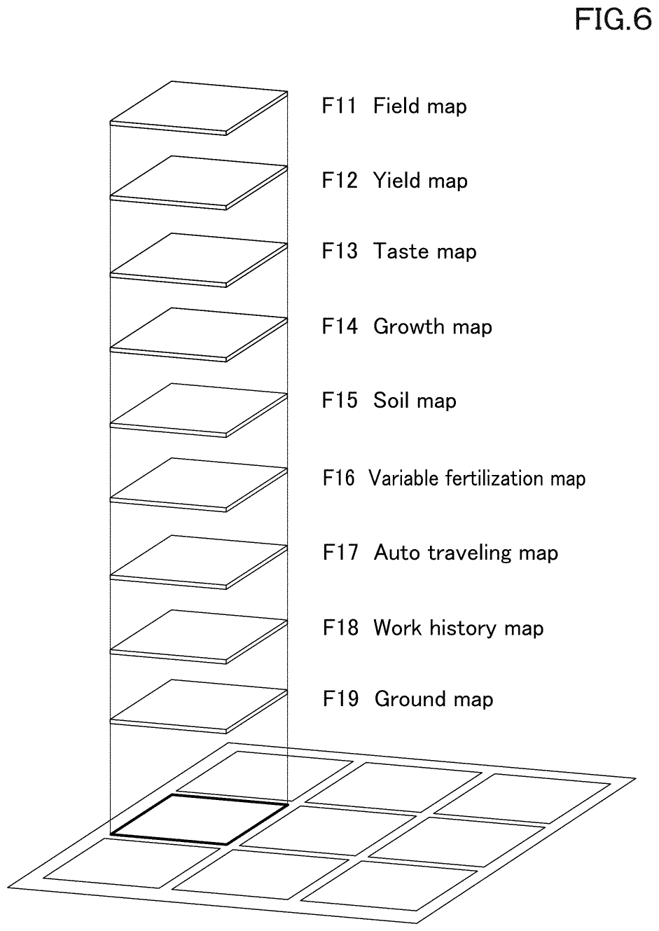

The agriculture support device 90 includes a display controller portion 97. The display controller portion 97 includes electrical and electronic components provided in the agriculture support device 90, computer programs stored in the agriculture support device 90, or the like. The display controller portion 97 causes the external terminal 15 to display an agricultural map that is obtained by visualizing the agricultural map data stored in the map data storage portion 93. As shown in FIG. 6, the agricultural map includes a field map F11 obtained by visualizing the field shape data, a yield map F12 obtained by the visualizing yield data, a taste map F13 obtained by visualizing the taste data, a growth map F14 obtained by visualizing the growth data, a soil map F15 obtained by visualizing the soil data, a variable fertilization map F16 obtained by visualizing the variable fertilization data, an automatic travel map F17 obtained by visualizing the automatic travel data, a work history map F18 obtained by visualizing the work history data, and a ground map F19 obtained by visualizing the map data.

As illustrated in FIG. 3, the work creator portion 91 displays the map display portion 109 on the creation screen M1 in cooperation with the display controller portion 97. That is, in displaying the creation screen M1 on the external terminal 15, the work creator portion 91 notifies the display controller portion 97 of displaying the map display portion 109 on the creation screen M1, and the display controller portion 97 displays an agricultural map on the map display portion 109 in response to the notification.

More specifically, the display controller portion 97 first refers to the map data storage portion 93, the agricultural map data that needs to be converted into a map is converted into the agricultural map among the agricultural map data stored in the map data storage portion 93, and then the agricultural map converted above is displayed in the map display portion 109. For example, the display controller portion 97 converts, into the agricultural map, the agricultural map data such as the yield data, the taste data, the growth data, the soil data, and the variable fertilization data.

In converting the agricultural map data into the agricultural map, the display controller portion 97 refers to the data such as numerical values and the position (latitude and longitude) in the agricultural map data (the yield data, the taste data, the growth data, the soil data, the variable fertilization data). As illustrated in FIG. 3, the display controller portion 97 divides the field in the map display portion 109 into a plurality of areas Qn (n=1, 2, 3, . . . , N), and defines a representative value Dn (n=1, 2, 3, . . . N) in each of the divided areas Qn (n=1, 2, 3, . . . , N), the representative value Dn being an average value obtained by averaging a plurality pieces of data Dn [i] (n: area, Dn [i]: data, i: number of data) included in each of the divided areas Qn in the agricultural map data. Alternatively, the display controller portion 97 defines a representative value Dn that is an integrated value obtained by integrating a plurality of data Dn [i] included in each of the divided areas Qn in the agricultural map data. Alternatively, the display controller portion 97 defines a representative value Dn that is a numerical value per area obtained by dividing the average value and the integrated value by the area of the area Qn.

After obtaining the representative value Dn, the display controller portion 97 assigns one of a plurality of groups (a plurality of ranks) according to the magnitude (the value) of the representative value Dn, and changes the color or the like for each of the ranks, thereby displaying the agricultural map. That is, the map display portion 109 divides a field indicating an agricultural field or the like into a plurality of areas, and thereby displays a mesh-type agricultural map in which data of agricultural map data is assigned to the area Qn. In addition, in the preferred embodiment mentioned above, the configuration in which the agricultural map is visualized by the mesh type map is exemplified. However, the visualized map of the agricultural map is not limited to the example described above.

When a plurality pieces of agricultural map data are stored in the map data storage portion 93, the map display portion 109 displays the plurality of agricultural maps arranged vertically or horizontally. When displaying the agricultural map on the map display portion 109, the display controller portion 97 preferably displays, around the agricultural map, basic map information such as the name of the agricultural map and the acquisition date of the agricultural map data.

The basic information (name, acquisition date, and the like) of the agricultural map is related to each of the agricultural map data (the management information) by connecting one of the terminal 15A and the terminal 15B to the agriculture support device 90 and by inputting the basic information. Note that the basic information may be automatically generated and associated with the management information, and may be stored in the map data storage portion 93. Thus, the inputting method and the relating method are not limited thereto.

Thus, since various types of agricultural maps (F11 to F19) are displayed on the map display portion 109 of the creation screen M1, the administrator and the like is capable of setting the items of agricultural work, the work date, the scheduled traveling route R1 and the like while watching the agricultural map on the map display portion 109.

Although a plurality of agricultural maps (F11 to F19) are displayed on the map display portion 109, a predetermined agricultural map related to a work plan set on the creation screen M1 among the plurality of agricultural maps may be displayed on the map display portion 109. The display controller portion 97 determines an agricultural map to be displayed on the map display portion 109 in accordance with the items of the agricultural work inputted to the work inputting portion 101 among a plurality of agricultural maps, for example. When the agricultural work is the fertilization, the display controller portion 97 causes the map display portion 109 to display an agricultural map (the variable fertilization map F16) related to the fertilization.

Thus, since the display controller portion 97 causes the external terminal 15 to display a predetermined agricultural map related to the creation of the work plan among the plurality of agricultural maps, the administrator or the like is capable of creating a plan while watching the items of agricultural work set on the creation screen M1 or the agricultural map according to the scheduled traveling route R1.

As shown in FIG. 1, the agriculture support device 90 has a communicator portion 95. The communicator portion 95 includes electric and electronic components provided in the agriculture support device 90, computer programs stored in the agriculture support device 90, or the like. The communicator portion 95 transmits the work plan created by the work creator portion 91 to an agriculture machine such as the tractor 1.

The communicator portion 95 transmits, to the tractor 1, the work plan created on the creation screen M1, that is, the work plan stored in the work plan storage portion 92. More specifically, when the communicator device 60A of the tractor 1 requests the transmission of a work plan, or when the terminal 15B capable of communicating with the tractor 1 requests the transmission of a work plan, the work plan (the agricultural field, the agricultural work, the model number, model and name of the agriculture machine (working device), work date, the scheduled traveling route R1, the working width, and the lapping width) are transmitted to the communicator device 60A or the terminal 15B that has requested. When the work plan is transmitted to the terminal 15B, the terminal 15B transfers the work plan to the input/output device 63 of the tractor 1 through the electronic storage medium.

The display device 80 includes a plan acquiring portion 81 and a display portion 82. The plan acquiring portion 81 includes electric and electronic components provided on the display device 80, computer programs stored in the display device 80, and the like. The plan acquiring portion 81 acquires the work plan transmitted from the communicator portion 95 of the agriculture support device 90. For example, the plan acquiring portion 81 instructs the communicator device 60A of the tractor 1 to request the agriculture support device 90 to acquire a work plan, and receives the work plan when the communicator device 60A receives the work plan. Alternatively, when the work plan is inputted to the input/output device 63 through the terminal 15B, the plan acquiring portion 81 fetches the work plan inputted to the input/output device 63. The display portion 82 includes a liquid crystal panel, a monitor, or the like.

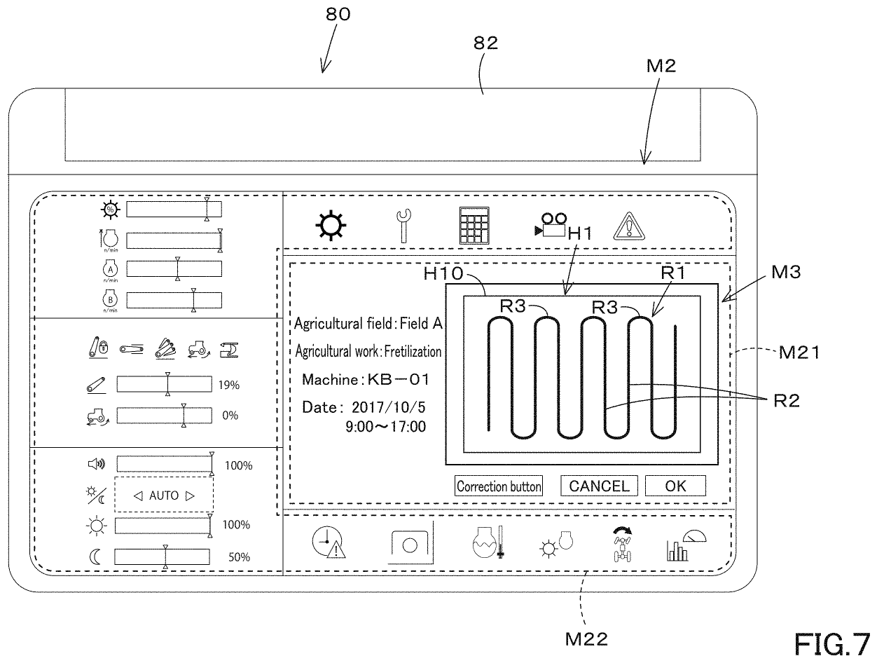

As shown in FIG. 7, when a predetermined operation is performed, the display device 80 displays a screen M2 on the display portion 82. The screen M2 is divided at least into a first area M21 and a second area M22. The first area M21 is an area for displaying at least outside information (external information) acquired by the tractor 1. The second area M22 is an area for displaying at least inside information (internal information) of the tractor 1.

When acquiring the work plan, the display device 80 displays a list of work plans that are the external information, and when a predetermined work plan is selected, the display device 80 displays a work plan screen M3 indicating the selected work plan in the first area M21.

In displaying the work plan screen M3 in the first area M21, the work plan screen M3 displays the agricultural work, a model number, model and name of agriculture machine (working device), a work date, the scheduled traveling route R1, the working width, and the lapping width.

The display device 80 evaluates the execution of the work plan based on the work plan acquired by the tractor 1. As shown in FIG. 1, the display device 80 includes a machine information acquiring portion 83 and an evaluator portion 84. The mechanical information acquiring portion 83 and the evaluator portion 84 include electric and electronic components provided on the display device 80, computer programs stored in the display device 80, and the like.

The machine information acquiring portion 83 requests the machine information of the agriculture machine to the working device 2, that is, requests the machine information of the working device 2 when the working device 2 is coupled to the coupler portion 8, when the ignition switch of the tractor 1 is turned on to activate the display device 80, and the like. In response to the request from the machine information acquiring portion 83, the working device 2 transmits a model number, a model, a name, and the like stored in advance in the working device 2 to the machine information acquiring portion 83 as the machine information. The machine information acquiring portion 83 holds the machine information transmitted from the working device 2. Note that the machine information acquiring portion 83 may periodically request the working device 2 for the machine information even after acquiring the machine information, and may acquire the machine information from the working device 2. Alternatively, the machine information may be periodically transmitted from the working device 2 to the display device 80, and the machine information acquiring portion 83 may acquire the machine information when the machine information is inputted to the display device 80.

In this manner, the model number, model, name, and the like of the working device 2 mounted on the tractor 1 can be acquired before starting the work or the like.

After the plan acquiring portion 81 acquires the work plan, when the machine information acquiring portion 83 acquires the machine information (the model number, the model, the name, and the like), the evaluator portion 83 compares the machine information to the work plan (the model number, the model, the name, and the like) acquired by the plan acquiring portion 81, and thereby evaluates the execution of the work plan. For example, the evaluator portion 84 compares the model number obtained from the working device 2 to the model number indicated in the work plan, and determines that the work plan can be executed when the model numbers match each other. On the other hand, the evaluator portion 84 compares the model number obtained from the working device 2 to the model number indicated in the work plan, and determines that the work plan cannot be executed when the model numbers do not match each other.

The evaluator portion 84 requests the machine information acquiring portion 83 to acquire the machine information when the machine information acquiring portion 83 has not acquired the machine information after the plan acquiring portion 81 acquires the work plan, and the evaluator portion 84 performs the evaluation when the machine information acquiring portion 83 has acquired the machine information. When the machine information acquiring portion 83 cannot acquire the machine information even if the evaluator portion 84 requests the machine information acquiring portion 83 to acquire the machine information, the evaluator portion 84 notifies the display portion 82 that the attachment confirmation of the working machine 2 is displayed, and the display portion 82 displays that the attachment of the work apparatus 2 is confirmed.

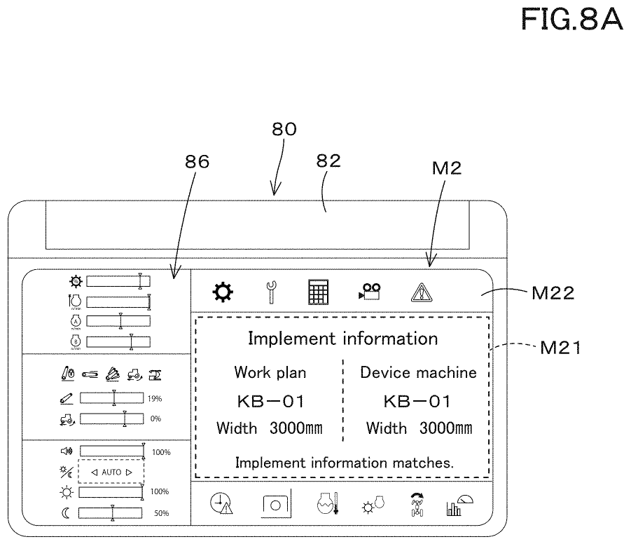

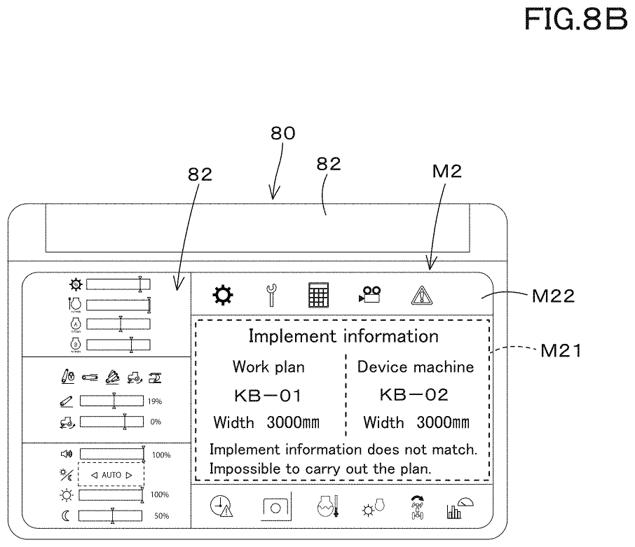

The display portion 82 displays the machine information and displays, as the evaluation result of the evaluator portion 84, whether or not the work plan can be executed. For example, as shown in FIG. 8A, the display portion 82 displays at least the model number obtained from the working device 2 and the model number indicated in the work plan, and when the model numbers match each other, the display portion 82 displays information representing that the machine information (the implement information) shown in the work plan matches each other and thus the work plan can be executed. As shown in FIG. 8B, when the model numbers do not match each other, the display portion 82 displays the model number obtained from the working device 2 and the model number shown in the work plan, and displays information indicating that the machine information (the implement information) shown in the work plan does not match each other and thus the work plan cannot be executed. In addition, when the model numbers do not match each other, the display portion 82 displays a message to prompt the user to change the working device 2.

In the case where the relation between the model number, the model, and the name and the detailed information such as the working width of the working device 2 is registered in the display device 80, the display portion 82 may display the detailed information such as the working width corresponding to the machine information as shown in FIGS. 8A and 8B.

When the evaluator portion 84 determines that the work plan cannot be executed, the display device 80 disables at least an input for shifting to execution of the work plan. For example, the reception of the input to the setting unit 86 displayed in the second area M22, that is, the reception of the input to the setting unit 86 for changing the setting of the tractor 1 or the working device 2 is stopped. In other words, the input to the user interface for changing the setting of the tractor 1 or the working device 2 is stopped.

In the above-described preferred embodiment, the evaluation is performed based on whether or not the implement information matches the work plan. However, the evaluator portion 84 may judge whether or not the work can be executed in the agricultural field specified in the work plan, based on an area of the agricultural field (an agricultural field area) and on the remaining amount of fuel mounted on the tractor 1 or the like, which is machine information. The above-described example is merely an example, and the evaluator portion 84 may perform the evaluation by comparing various types of machine information with a work plan.

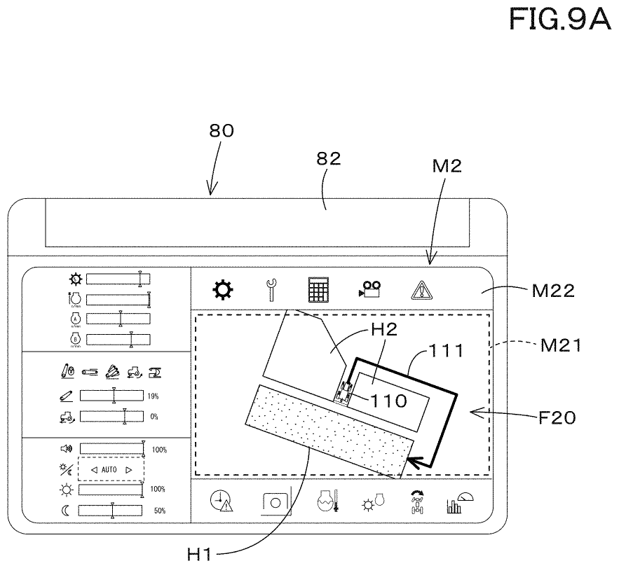

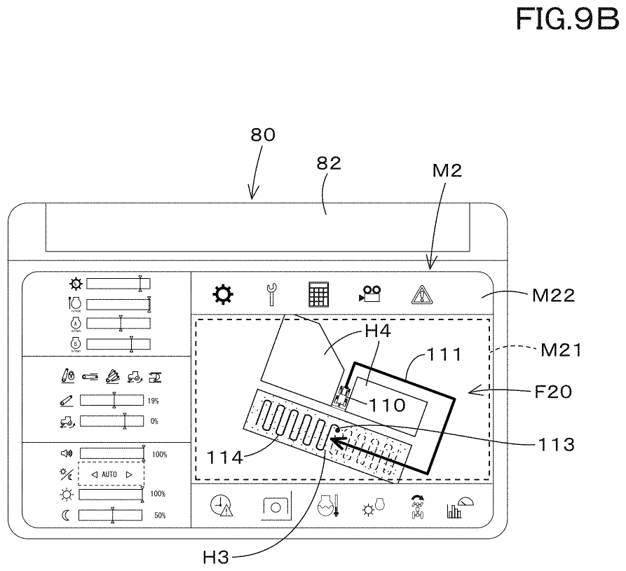

Now, as shown in FIG. 9A, the display portion 82 of the display device 80 displays, in the first area M21, a work map F20 including the agricultural field represented in the work plan. The work map F20 is a map registered in the display device 80 in advance. Note that map data including an agricultural field may be acquired with the agriculture support device 90 or the like, and the map data acquired above may be used as the work map F20.

More specifically, the display portion 82 extracts a work plan to be performed on the day (referred to as a current day plan) from among a plurality of work plans, using the work date as a key, and the display portion 82 displays, on the work map F20, an agricultural field (referred to as a work target field) H1 indicated by the current day plan extracted above. In addition, the display portion 82 respectively displays the target work field H1 and the other fields H2 other than the target work field H1 in different colors from among the plurality of work plans on the work map F20. The display portion 80 may display both the graphic 110 indicating the current position of the tractor 1 and the target work field H1 on the work map F20, and may display the guidance route 111 from the current position to the entrance of the target work field H1.

In addition, as shown in FIG. 9B, the display portion 82 of the display device 80 displays a position (interruption position) 113 where the agricultural work is interrupted when the agricultural work is performed by the tractor in accordance with the work plan. In particular, the display portion 82 of the display device 80 displays the traveling locus 114 on the work map F20 based on the position detected by the position detector device 70A (on a detected position). For example, when the operation interruption is instructed by an input to the display device 80, the detected position at the time when the interruption is instructed is held as the interruption position 113. In addition, in the agricultural work in which the work was interrupted, the work name or the like indicating the agricultural work is also held as the interruption position. Here, when the tractor 1 moves to another place after the interruption of the operation and resumes the operation, the field H3 where the operation was interrupted (a target interruption field) and the other fields H4 other than the target interruption field H3 are respectively displayed in different colors. The display portion 80 may display both the graphic 110 indicating the current position and the target interruption field H3 on the work map F20, and may display the guidance route 111 from the current position to the interruption position 113 in the target interruption field H3.

Thus, by receiving the work plan transmitted from the agriculture support device 90 on the tractor 1 side and by displaying the work plan received above on the display device 80, it is possible to perform agricultural work by the tractor 1 corresponding to the work plan.

Now, on the tractor 1 side, it is possible to judge whether the agricultural work indicated in the work plan has been performed in accordance with the instruction. The display device 80 includes a work judgment portion 87. The work judgment portion 87 includes electric/electronic components or circuitry provided in the display device 80, computer programs stored in the display device 80, or the like.

When the evaluator portion 84 determines that the work plan can be executed, the work judgment portion 87 judges during the work by the tractor 1 whether the agricultural work indicated in the work plan has been completed by the tractor 1. For example, the work judgment portion 87 judges whether or not the agricultural work indicated in the work plan has been completed by the tractor 1 based on the traveling locus 114 in the field represented in the work plan, that is, in the target work field H1.

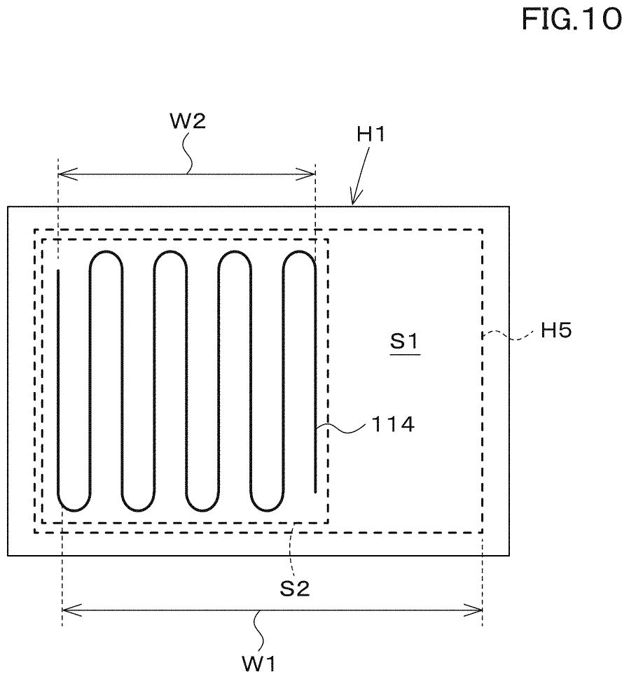

As shown in FIG. 10, when a notification of the end of the work is given by performing a predetermined operation on the display device 80, the work judgment portion 87 compares, in the target work field H1, a width W1 of an area (a work area) where the work can be performed to the execution width W2 obtained by adding the work width of the working device 2 and the like to the outermost line (excluding the turning portion) in the traveling locus 114.

Alternatively, the work judgment portion 87 compares the area S1 of the work area H5 with the execution area S2 obtained from the traveling locus 114 and the work width. The work area H5 is an area where work can be substantially performed by the tractor 1 or the like. For example, the work area H5 is an area set based on a position detected by a detection position 70 that detects an area in which the tractor 1 can travel in the target work field H1, the area being obtained by the tractor 1 that has travelled around the target work field H1 before setting the scheduled traveling route R1 or in registering a work map to the display device 80. In addition, a portion preliminarily excluding a region shifted inward by a predetermined distance from the contour of the ridge of the target work field H1 or the like may be set as the work region H5.

When the width W1 of the work area H5 is larger than the execution width W2, when the area S1 is larger than the execution area S2, and the like, the work judgment portion 87 determines that the tractor 1 has not completed the agricultural work indicated in the work plan. That is, the work judgment portion 87 determines that the agricultural work indicated in the work plan is not completed by the tractor 1 when the area where the work is performed by the tractor 1 is smaller than the area where the agricultural work must be actually performed, thereby remaining unfinished work. In the preferred embodiment mentioned above, the comparison between the width W1 and the execution width W2 of the work area H5 and the comparison between the area S1 and the execution area S2 are performed, and the work area H5 is sometimes a little larger due to a setting error and the like. Thus, the work judgment portion 87 may determine that the work plan has been executed even when the execution width W2 is smaller than the width W1 or the area S1 by an error range (a few percent).

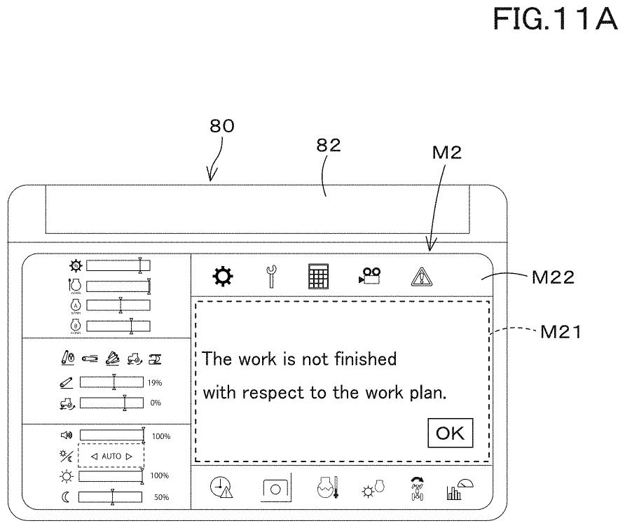

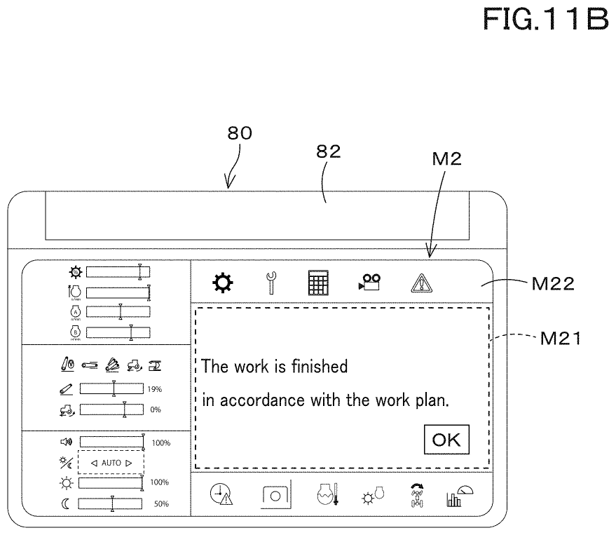

When the work judgment portion 87 determines that the agricultural work has not been completed by the tractor 1, the display portion 82 of the display device 80 displays that the work has not been completed in accordance with the work plan, as shown in FIG. 11A. On the other hand, when the work judgment portion 87 determines that the tractor 1 has completed the agricultural work, the display portion 82 of the display device 80 displays that the work has been completed in accordance with the work plan, as shown in FIG. 11B.

When the completion of work is notified, the display device 80 notifies any one of the controller device 12 and the communicator device 60A of the completion of work. In the direct communication, when the completion of work is notified, the communicator device 60A transmits, to the agriculture support device 90, any one of the work result (a first work result) stored in the controller device 12 , the work result (a second work result) stored in the communicator device 60A, and the work result (a third work result) stored in the display device 80. In the indirect communication, the communicator device 60A transmits, to the terminal 15B, any one of the first work record, the second work record, and the third work record. After receiving the work record, the terminal 15B transmits the work record received above to the agriculture support device 90.

When the display device 80 notifies the completion of work and when the work judgment portion 87 determines that the agricultural work is completed, the communicator device 60A may transmit the work result to any one of the agriculture support device 90 and the terminal 15B.

Upon reception of the work result, the agriculture support device 90 stores the work result received above in the result storage portion 99 including a nonvolatile memory or the like.

In this manner, after displaying the work plan on the display device 80, the work result obtained when the operator or the like has executed the agricultural work with the agriculture machine such as the tractor 1 can be transmitted to the agriculture support device 90 and stored. In particular, the work result based on the work plan is transmitted to the agriculture support device 90 after the work plan is displayed on the display device 80, so that the transmission certifies that the tractor 1 confirms the correspondence between the work plan and the work result. In addition, the reliability of data of the work result data for a work plan can be improved.

The agriculture support system includes the agriculture support device 90 having the work creator portion 91 and the communicator portion 95, and the display device including the machine information acquiring portion 83, the plan acquiring portion 81, the evaluator portion 84, and the display portion 82 and being provided to the agriculture machine.

According to that configuration, the work plan created by the work creator portion 91 of the agriculture support device 90 can be acquired by the display device 80 side provided in the agriculture machine, and the evaluation of execution of work plan can be performed based on the work plan acquired above and the machine information of the agriculture machine. In addition, since the evaluation result can be displayed on the display device 80, the operator who boards on the agriculture machine can confirm the evaluation. That is, an operator or the like can easily confirm items related to the execution of the agricultural work on the agriculture machine side.

The evaluator portion 84 evaluates whether the work plan can be executed based on the machine information of the working device 2 provided in the agriculture machine, and the display portion 82 displays whether or not the work plan can be executed as the evaluation result together with the machine information.

According to that configuration, the operator who boards on the agriculture machine can easily confirm whether or not the work plan can be executed by the operation of the working device 2 provided to the agriculture machine 2.

The display portion 82 displays the evaluation result in an area of the display device 80 where the external information is allowed to be displayed. According to that configuration, since the evaluation result is displayed in the area of the display device 80 where the external information is displayed, the operator can easily find that the evaluation result is displayed in the area, and thus the operator can be easily aware of the evaluation result.

The display portion 82 displays the position where the agricultural work was interrupted during the agricultural work being performed by the agriculture machine in accordance with the work plan. According to that configuration, the position at which the agricultural work was interrupted is easily determined, and even when the agriculture machine is located at a position different from the interruption position, the operator can easily move the agriculture machine to the interruption position.

The display device 80 includes the work judgment portion 87 configured to judge whether or not the agricultural work represented in the work plan has been completed by the agriculture machine during the work of the agriculture machine when the evaluator portion 84 determines that the work plan can be executed, and the display portion 82 displays a judgment result by the work judgment portion 87.

According to that configuration, when the work plan can be performed by the agriculture machine, it can be easily determined whether or not the work for the work plan is being executed reliably (whether or not the work has been completed).

The work judgment portion 87 judges whether or not the agricultural work represented in the work plan has been completed by the agriculture machine based on at least the travel locus of the agriculture machine that has traveled on the agricultural field represented in the work plan. According to that configuration, it is possible to easily judge, based on the traveling locus, whether the agricultural work has been performed in accordance with the work plan based on the traveling locus.

In the preferred embodiment mentioned above, the display controller portion 97 displays the agricultural map on the external terminal 15 in creating the work plan. However, the agricultural map may be displayed on the display device 80.

As shown in FIG. 1, the agriculture support device 90 includes the data transmitter portion 98. The data transmitter portion 98 includes electric/electronic components or circuitry provided in the agriculture support device 90, computer programs stored in the agriculture support device 90, or the like. The data transmitter portion 98 transmits a plural pieces of agricultural map data stored in the map data storage portion 93 to the outside. For example, in the case where the direct communication can be performed, the display device 80 requests the communicator device 60A to transmit the agricultural map data when a predetermined operation is performed on the display device 80. The communicator device 60A requests the agriculture support device 90 to transmit the agricultural map data in response to the request for transmitting the agricultural map data transmitted from the display device 80. The data transmitter portion 98 transmits a plurality pieces of agricultural map data stored in the map data storage portion 93 to the communicator device 60A in response to the request from the communicator device 60A. When the communicator device 60A receives the plural pieces of agricultural map data, the display device 80 stores the plural pieces of agricultural map data in the storage portion (the data storage portion) 88 including a nonvolatile memory or the like.

When a predetermined operation is performed on the display device 80 in the case where the indirect communication can be performed, the display device 80 requests the terminal 15B to transmit the agricultural map data. The terminal 15B requests the agriculture support device 90 to transmit the agricultural map data in response to the request for transmission of the agricultural map data from the display device 80. The data transmitter portion 98 transmits a plural pieces of agricultural map data stored in the map data storage portion 93 to the terminal 15B in response to the request from the terminal 15B. When the terminal 15B receives the plural pieces of agricultural map data, the display device 80 acquires a plural pieces of agricultural map data through the communicator device 60A, and stores, in the data storage portion 88, the plural pieces of agricultural map data acquired above.

In the case when the tractor 1 is not provided with the communicator device 60A or the like, the terminal 15A or the terminal 15B is operated to request the agriculture support device 90 to transmit the agricultural map data. The data transmitter portion 98 transmits a plural pieces of agricultural map data to the terminal 15A or the terminal 15B in response to the request from the terminal 15A or the terminal 15B. When a storage medium is connected to the terminal 15A or the terminal 15B, the plural pieces of agricultural map data acquired by the terminal 15A or the terminal 15B is transferred to the storage medium. When the input/output device 63 is connected to the storage medium, the plural pieces of agricultural map data are transferred to the input/output device 63. When the input/output device 63 acquires the plural pieces of agricultural map data, the display device 80 stores the agricultural map data acquired above in the data storage portion 88.

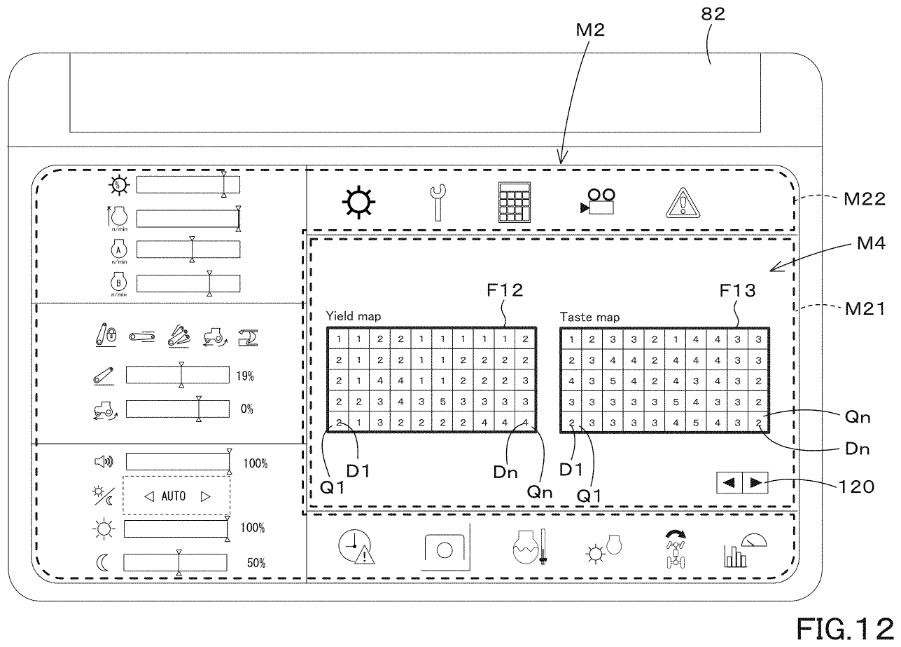

When a predetermined operation is performed on the display device 80, the display device 80 displays a layer map screen M4 in the first area M21 of the display screen M2 as shown in FIG. 12.

The layer map screen M4 is configured to display an agricultural field map F11, a harvest map F12, a taste map F13, a growth map F14, a soil map F15, a variable fertilization map F16, an automatic traveling map F17, a work history map F18, and a ground map F19. That is, on the layer map screen M4, a plurality of agricultural maps can be displayed, similarly to the external terminal 15.

For example, the display device 80 refers to the data storage portion 88, converts, into an agricultural map, the agricultural map data which needs to be converted into a map from among the agricultural map data stored in the data storage portion 88, and displays the agricultural map converted above on the layer map screen M4. For example, the display device 80 converts, into the agricultural map, the agricultural map data, that is, the yield data, the taste data, the growth data, the soil data, and the variable fertilization data.

For example, the display device 80 refers to data such as numerical values and positions (latitude and longitude) in the agricultural map data (the yield data, the taste data, the growth data, the soil data, the variable fertilization data). On the other hand, the display device 80 divides the field on the layer map screen M4 into a plurality of areas Qn (n=1, 2, 3, . . . , N), and sets, as the representative value Dn (n=1, 2, 3, . . . , N), the average value of the data Qn [i] (n: section, Qn [i]: data, i: number of pieces of data) to enter each of the areas Qn divided in the agricultural map data. Alternatively, the display device 80 sets, as the representative value Dn, an integrated value of the plural pieces of data Qn [i] to enter each of the areas Qn divided in the agricultural map data. Alternatively, the display device 80 sets, as the representative value Dn, a value per area obtained by dividing the average value or the integrated value with the area of the area Qn.

After obtaining the representative value Dn, the display device 80 allocates the representative value Dn to one of a plurality of groups (a plurality of ranks) depending on the magnitude (the value) of the representative value Dn, and changes the color or the like depending on the ranks, thereby displaying the agricultural map. That is, the layer map screen M4 displays a mesh-type agricultural map in which the field representing an agricultural field or the like into a plurality of areas and the data of the agricultural map data is assigned to the area Qn. The preferred embodiment mentioned above describes the example in which the agricultural map is visualized in a map format of the mesh type. However, the visualized map of the agricultural map is not limited to the above-described example.

As shown in FIG. 12, a switch portion 120 is displayed on the layer map screen M4. When the switch portion 120 is selected, the agricultural map displayed on the layer map screen M4 is changed. For example, when the switch portion 120 is selected under the state where the yield map F12 and the taste map F13 are displayed on the layer map screen M4, the display is changed from the yield map F12 and the taste map F13 to the growth map F14 and the soil map F15. Thus, the map F14 and the soil map F15 are displayed on the layer map screen M4. That is, every time when the switch portion 120 is selected, the agricultural map is switched to be displayed.

In addition, the display device 80 may display the agricultural map corresponding to the work plan on the layer map screen M4. When displaying the agricultural map on the layer map screen M4, the display device 80 extracts the current day plan from the plurality of work plans, for example. In the case where the agricultural work represented in the current day plan is the fertilization, the display device 80 displays, on the layer map screen M4, the agricultural map (variable fertilization map F16) on fertilization. In the case where there are a plurality of the current day plans, the agricultural maps corresponding to the current day plans can be displayed sequentially by selecting the switch portion 120.

The agricultural support system includes the agriculture support device 90 that includes the map data storage portion 93 configured to store the agricultural map data, and the display device 80 configured to acquire the agricultural map data. The display device 80 includes the display portion 82 configured to display a plurality of the agricultural maps in which the plural pieces of agricultural map data acquired above are visualized. The agriculture support device 90 includes the display controller portion 97 configured to display, on the external terminal 15 different from the display device 80, the plurality of agricultural maps in which the plural pieces of agricultural map data stored in the map data storage portion 93 are visualized.

According to that configuration, not only is the external terminal 15 capable of displaying the agricultural map visualizing the agricultural map data, but also the display device 80 is also capable of displaying the agricultural map. As the result, the operator can confirm a plurality of agricultural maps on the external terminal 15 while confirming a plurality of agricultural maps on the display device 80. That is, since the agricultural map can be confirmed at various places, the operator can perform the agricultural work according to a condition.

The agriculture support device 90 includes the work creator portion 91 configured to create a work plan for agricultural work for the external terminal 15, and the display portion 82 displays a plurality of agricultural maps that visualize the work plan created by the work creator portion 91 and the plural pieces of agricultural map data transmitted from the data transmitter portion.

According to that configuration, the operator is allowed to watch both of the work plan and the plurality of agricultural maps, and the operator is allowed to perform the agricultural work while watching the relation between the work plan and the plurality of agricultural maps.

The display portion 82 displays, as the agricultural map, data of areas shared with each of the plurality of agricultural maps.

According to that configuration, it is possible to compare each other data of areas shared with the plurality of agricultural maps. For example, it is possible to compare each other data of the same area of each of the yield data, the taste data, the growth data, the soil data, the variable fertilization data, the automatic traveling data, and the work history data.

The display portion 82 displays a predetermined agricultural map related to the work plan among a plurality of the agricultural maps. The display controller portion 97 causes the external terminal 15 to display a predetermined agricultural map related to creation of the work plan among the plurality of agricultural maps. In this manner, it becomes easy to know the relation between the agricultural map and the work plan. For example, when the agricultural work is included in the work plan, the operator can easily watch the agricultural map related to the agricultural work.

The display portion 82 includes the first area M21 that displays at least the external information transmitted from the agriculture support device 90 and includes the second area M22 that displays at least the internal information different from the external information, and the plurality of agricultural maps are displayed in the first area M21. In this manner, the agricultural map is displayed in the first area M21 in which the external information is displayed while the internal information and the external information are distinguished, so that the operator can easily check the agricultural map. For example, when the internal information is information on the setting of the agriculture machine and the like, the setting of the agriculture machine can be performed while watching the agricultural map.

The agriculture machine includes the communicator device 60A configured to transmit, to the agriculture support device 90, the operation result of the agriculture machine obtained when the agricultural work is performed based on the work plan displayed on the display device 80. The agriculture support device 90 has the result storage portion 99 configured to store the work result that is transmitted by the communicator device 60A. According to that configuration, it is possible to leave the work results of the executed work on the agriculture support device 90 side while watching the work plan.

In the preferred embodiment mentioned above, the work plan screen M3 of the display device 80 displays the work plan (the agricultural work, the model number of the agriculture machine, the model, the name, the work date, the scheduled traveling route R1, the work width, the lapping width). However, the work plan may be corrected by the display device 80. For example, the display device 80 includes the corrector portion 89. The corrector portion 89 includes electrical/electronic components or circuitry provided in the display device 80, computer programs stored in the display device 80, or the like. When a predetermined operation is performed on the display device 80, for example, when a correction button displayed on the work plan screen M3 is selected, the corrector portion 89 allows the work plan to be corrected. When the correction of the work plan by the corrector portion 89 is permitted, the corrector portion 89 accepts the input of the work plan inputted by operation of the display device 80, and rewrites any one of the agricultural work, the model number of the agriculture machine, the model, the name, the work date, and the scheduled traveling route R1, the work width, and the lapping width into the newly inputted contents. After the correction of the work plan, the corrector portion 89 transmits the corrected work plan to the communicator device 60A together with information representing that the work plan has been corrected. The communicator device 60A transmits the corrected work plan to the support device 90. The communicator portion 95 of the support device 90 receives the corrected work plan, and the support device 90 stores the corrected work plan received above.

In the above description, the preferred embodiments of the present invention has been explained. However, all the features of the preferred embodiments disclosed in this application should be considered as just examples, and the preferred embodiments do not restrict the present invention accordingly. A scope of the present invention is shown not in the above-described preferred embodiments but in the claims, and is intended to include all modified examples within and equivalent to a scope of the claims.

When the work plan is created, unique identification information (for example, ID) corresponding to a created work plan may be issued. For example, in the case where a work represented in a work plan is performed by an agriculture machine such as a tractor, the identification information corresponding to the work plan is assigned to the work history data (the work history map) and managed, so that it is possible to know which work the work history data (the work history map) corresponds to.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An agriculture support system comprising:
an agriculture support device including:
a work creator to create a work plan of an agricultural operation to be performed by an agriculture machine; and
a communicator to transmit the work plan from the work creator; and
a display provided in the agriculture machine, the display including:
a machine information obtainer to obtain machine information of the agriculture machine;
a plan obtainer to obtain the work plan transmitted from the communicator; and
an evaluator to compare the work plan with the machine information obtained by the machine information obtainer and to evaluate the work plan; wherein
an evaluation result provided by the evaluator is displayed on the display.

2. The agriculture support system according to claim 1, wherein
the evaluator evaluates whether it is possible to carry out the work plan based on the machine information of a working device provided in the agriculture machine; and
the display displays the machine information and the evaluation result showing whether it is possible to carry out the operation.

3. The agriculture support system according to claim 1, wherein the display includes:
a first area to display outside information transmitted from the agriculture support device; and
a second area to display inside information different from the outside information; wherein
the first area displays the evaluation result provided by the evaluator.

4. The agriculture support system according to claim 1, wherein the display displays a position where the agricultural operation is interrupted when the agricultural operation is performed by the agriculture machine in accordance with the work plan.

5. The agriculture support system according to claim 1, wherein the display includes an operation analyzer to judge whether the agricultural operation represented in the work plan is finished by the agriculture machine during operation of the agriculture machine when the evaluator determines that it is possible to carry out the work plan.

6. The agriculture support system according to claim 5, wherein the operation analyzer judges, based on a traveling locus of the agriculture machine, whether the agricultural operation represented in the work plan is finished by the agriculture machine with respect to an agricultural field represented in the work plan.

7. The agriculture support system according to claim 1, wherein the display includes:
a corrector to correct the work plan displayed on the display; wherein
the communicator receives the work plan corrected by the corrector.
